(19) United States
(12) Patent Application Publication
(10) Pub. No.: US 2010/0189116 A1
(43) Pub. Date: Jul. 29, 2010

(54) Routing A Packet Flow In A VLAN

(75) Inventor: Stephen J. Brolin, Livingston, NJ (US)

Correspondence Address: BAKER BOTTS L.L.P., 2001 ROSS AVENUE, SUITE 600, DALLAS, TX, 75201-2980, US

(73) Assignee: Fujitsu Network Communications, Inc., Richardson, TX (US)

(21) Appl. No.: 12/358,560

(22) Filed: Jan. 23, 2009

(51) Int. Cl. H04L 12/56

(52) U.S. Cl. 370/401

(57) ABSTRACT

According to one embodiment, routing a packet flow includes routing the packet flow from a sender along a first VLAN to a receiver by applying a first service tag to the packet flow. The first service tag comprises a first VLAN identifier with a first masked portion indicating the first VLAN, where the first masked portion is masked to the receiver. The packet flow is sent to the receiver along the first VLAN. The packet flow is switched to a second VLAN associated with the first VLAN by applying a second service tag to the packet flow. The second service tag comprises a second VLAN identifier with a second masked portion indicating the second VLAN, where the second masked portion is masked to the receiver. The packet flow is sent to the receiver along the second VLAN.

### TECHNICAL FIELD

This invention relates generally to the field of telecommunications and more specifically to routing a packet flow in a VLAN.

### BACKGROUND

A virtual local area network (VLAN) is a set of network elements that behave as if they were connected to the same network segment even though they may be physically located on different network segments. VLANs may be set up and modified using software instead of requiring hardware additions or changes. A sender may send a packet flow along a VLAN to a receiver.

### SUMMARY OF THE DISCLOSURE

In accordance with the present invention, disadvantages and problems associated with previous techniques for communicating a packet flow along a virtual local area network may be reduced or eliminated.

According to one embodiment, routing a packet flow includes routing the packet flow from a sender along a first VLAN to a receiver by applying a first service tag to the packet flow. The first service tag comprises a first VLAN identifier with a first masked portion indicating the first VLAN, where the first masked portion is masked to the receiver. The packet flow is sent to the receiver along the first VLAN. The packet flow is switched to a second VLAN associated with the first VLAN by applying a second service tag to the packet flow. The second service tag comprises a second VLAN identifier with a second masked portion indicating the second VLAN, where the second masked portion is masked to the receiver. The packet flow is sent to the receiver along the second VLAN.

According to one embodiment, routing a packet flow includes dividing the packet flow into a first packet sub-flow and a second packet sub-flow. A first service tag is applied to the first packet sub-flow. The first service tag comprises a first VLAN identifier with a first masked portion indicating the first VLAN, where the first masked portion is masked to the receiver. The first packet is sent sub-flow along the first VLAN to a receiver. A second service tag is applied to the second packet sub-flow. The second service tag comprises a second VLAN identifier with a second masked portion indicating a second VLAN associated with the first VLAN, where the second masked portion is masked to the receiver. The second packet sub-flow is sent along the second VLAN to the receiver.

Certain embodiments of the invention may provide one or more technical advantages. A technical advantage of one embodiment may be that a sender may send a packet flow along two or more associated virtual local area networks (VLANs) to a receiver. To the receiver, the packets appear to have been received from the same VLAN.

Another technical advantage of one embodiment may be that the sender may send a packet flow to a receiver along a first associated VLAN and then switch the packet flow to a second associated VLAN. In certain embodiments, the first VLAN may be a working VLAN, and the second VLAN may be a protection VLAN.

Another advantage of one embodiment may be that the sender may split a packet flow into packet sub-flows and concurrently send a first packet sub-flow along a first associated VLAN and a second packet sub-flow along a associated second VLAN. In certain embodiments, the first packet sub-flow may have higher priority packets, and the second packet sub-flow may have lower priority packets.

Another technical advantage of one embodiment may be that a VLAN identifier that identifies the associated VLANs may include a masked portion that indicates the particular VLAN. The masked portion may be masked to the receiver such that the associated VLANs appear to the receiver as the same VLAN.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a system that uses associated VLANs to communicate packet flows;

FIG. 2 illustrates one embodiment of a method for switching a packet flow from one associated VLAN to another associated VLAN; and

FIG. 3 illustrates one embodiment of a method for sending sub-flows along associated VLANs.

### DETAILED DESCRIPTION OF THE DRAWINGS

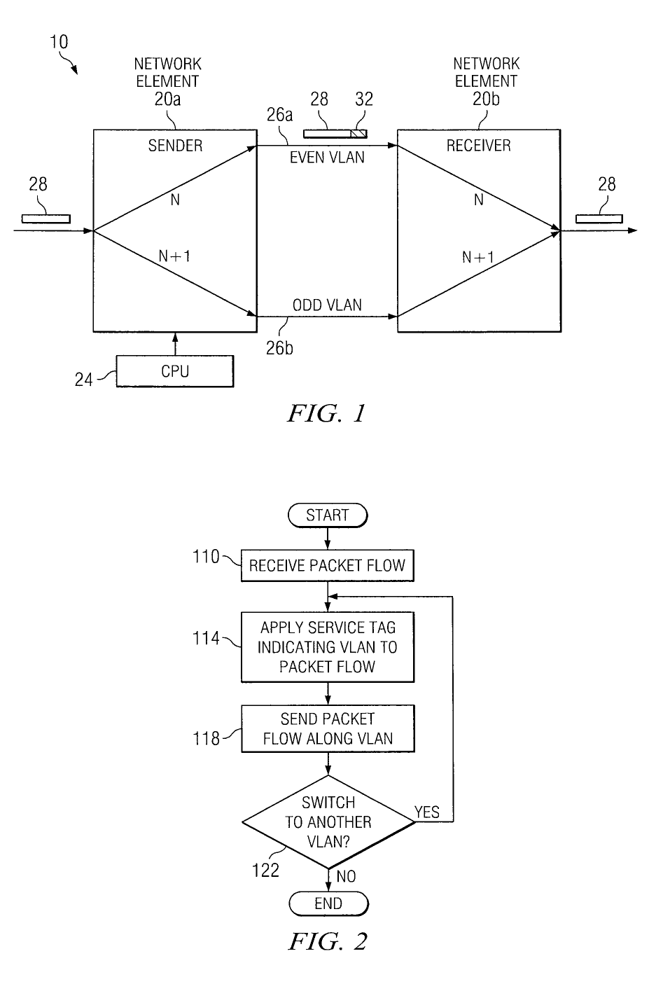

Embodiments of the present invention and its advantages are best understood by referring to FIGS. 1 through 3 of the drawings, like numerals being used for like and corresponding parts of the various drawings.

FIG. 1 illustrates one embodiment of a system 10 that uses associated VLANs to communicate packet flows. System 10 has two or more associated virtual local area networks (VLANs) that a packet flow may take from a sender to a receiver. For example, the sender may send a packet flow to the receiver along a first VLAN and then switch the packet flow to a second VLAN. As another example, the sender may split a packet flow into packet sub-flows and concurrently send a first packet sub-flow along a first VLAN and a second packet sub-flow along a second VLAN. To the receiver, packets that are received from associated VLANs appear to have been received from the same VLAN.

In the illustrated embodiment, system 10 includes two or more network elements 20 (20a and/or 20b), and a central processing unit (CPU) 24. In particular embodiments, a network element 20 represents equipment used to provide a telecommunications service. Examples of network elements include routers, network processors, switches (such as Ethernet switches), wavelength division multiplexers (WDMs), access gateways, endpoints, softswitch servers, trunk gateways, access service providers, Internet service providers, or other device operable to route packets through, to, or from system 10. In the illustrated embodiment, network elements 20 include a sender 20a and a receiver 20b. In certain embodiments, network element 20 represents represents a switch or network processor with setting changes that are configured by a CPU.

A VLAN 26 (26a and 26b) is a set of network elements 20 that behave as if they were connected to the same network segment even though they may be physically connected to different network segments. In certain embodiments, VLANs 26 that are associated with each other appear to be the same VLAN 26 to a network element. For example, receiver 20b that receives packet flows from different associated VLANs 26 may see the packet flows as received from the same VLAN 26.

In certain embodiments, a header (for example, a IEEE 802.1 header) of a frame may include one or more tags. A tag may include a tag protocol identifier (TPID) and/or tag control information (TCI). The TPID indicates that the frame carries a particular type of tag information. The TCI may include a user priority, a canonical format indicator (CFI), and a VLAN identifier (VID). The VID identifies the VLAN to which the frame belongs. For example, a service tag (S-TAG) identifies the service VLAN (S-VLAN) to which the frame belongs.

In certain embodiments, a packet (or frame) 28 may have a header with a tag 32 with information that indicates which one of a number of associated VLANs the packet is to use. The information may be masked to receiver 20b, such that receiver 20b sees a packet received from any of the associated VLANs as received from the same VLAN. For example, the header of the packet may have a service tag that comprises a masked portion indicating a particular associated VLAN, and may be masked to the receiver.

In certain embodiments, a service tag may include an SVID. In SVID may be N or N+1 to indicate one of two associated VLANs. In the embodiments, N is even, and the masked portion indicating the particular associated VLAN may be the least significant bit of the VID. In certain embodiments, N may be odd, and another suitable procedure may be used to mask the portion indicating the particular associated VLAN.

In certain embodiments, if the number of associated VLANS is x, then the masked portion indicating the particular associated VLAN may be the least y significant bits of the VID, where x=2^{y}. For example, for 2 VLANs, the masked portion comprises the least significant bit; for 4 VLANs, the masked portion comprises the least two significant bits; and for 8 VLANs, the masked portion comprises the least three significant bits.

In certain embodiments, sender 20a performs routing procedures, for example, applying service tags to packets, in response to instructions from CPU 24. The communication along the associated VLANs may be regarded as single-ended because only the sender 20a needs to perform the switching or aggregating processes. In addition, there is no need to coordinate any change or packet flow routings with receiver 20b. Receiver 20b need not perform any additional operations. Receiver 20b just receives the packet flows from either or both associated VLANs as if the packet flows were received from the same VLANs.

In certain examples of operation, sender 20a may route a packet flow along a first VLAN to receiver 20b by applying a first service tag to the packet flow. Sender 20a sends the packet flow to receiver 20b along the first VLAN. Sender 20a may switch the packet flow to a second VLAN by applying a second service tag to the packet flow and sending the packet flow to receiver 20b along the second VLAN. Since the masked portions are masked to receiver 20b, the receiver need not be aware of the switching. In these examples of operation, the first VLAN may be regarded as a working VLAN, and the second VLAN may be regarded as a protection VLAN.

In other examples of operation, the associated VLANs may be aggregated. Sender 20a may divide a packet flow into a first packet sub-flow and a second packet sub-flow. Sender 20a may apply a first service tag to the first packet sub-flow and send the first packet sub-flow along a first VLAN to receiver 20b. Sender 20a may apply a second service tag to the second packet sub-flow and send the second packet sub-flow along a second VLAN to receiver 20b. In these examples of operation, the VLANs may be regarded as aggregated VLANs.

A component of system 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input and/or performs the operations of a method. Logic may include hardware, software, and/or other logic. Logic may be encoded in one or more tangible media and may perform operations when executed by a computer. Certain logic, such as a processor, may manage the operations of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

FIG. 2 illustrates one embodiment of a method for switching a packet flow from one associated VLAN to another associated VLAN. The method may be performed in real time as sender 20a receives and sends packets.

The method begins at step 110, where sender 20a receives a packet flow that includes packets 28. Sender 20a applies a service tag that indicates a particular associated VLAN to packets 28 of packet flow at step 114. For example, sender 20a applies a service tag that includes a VLAN identifier of N to indicate even VLAN 26a.

Sender 20a sends a packet flow along VLAN 26a at step 118. Receiver 20b receives the packet flow. The packet flow may be switched to an associated VLAN at step 122. Sender 20a may determine to switch the flow in any suitable manner. For example, sender may receive notification that a failure has been detected on the current VLAN 26a, and switching the packet flow to the other VLAN 26b in response to the determination. As another example, sender may receive a user request to switch the packet flow to the other VLAN 26b, and switch the packet flow to the other VLAN 26b in response to the user request.

Sender 20a may switch to another VLAN 26b in any suitable manner, such as any suitable time. In one embodiment, sender 20a may switch the packet flow during a dead zone. A dead zone may refer to a planned duration when traffic is not communicated to and/or from sender 20a and/or receiver 20b. Examples of a dead zone include a timeout or purge period used when switching a flow from one path to a another path. No packets are sent during the dead zone, even if packets are dropped during this interval. The dead zone avoids out of sequence packets due to different propagation delays of the paths.

In another embodiment, sender 20a may insert one or more switching indicator packets into the packet flow to notify receiver 20b that the packet flow is being switched. For example, a switching indicator packet may be sent when switching starts and/or when switching ends.

If the packet flow is to be switched to an associated VLAN at step 122, the method returns to step 114, where sender 20a applies a service tag indicating the other VLAN 26b to the packet flow. For example, sender 20a may attach a service tag with a VLAN identifier N+1 that indicates odd VLAN 26b. If the packet flow is not to be switched at step 122, the method ends.

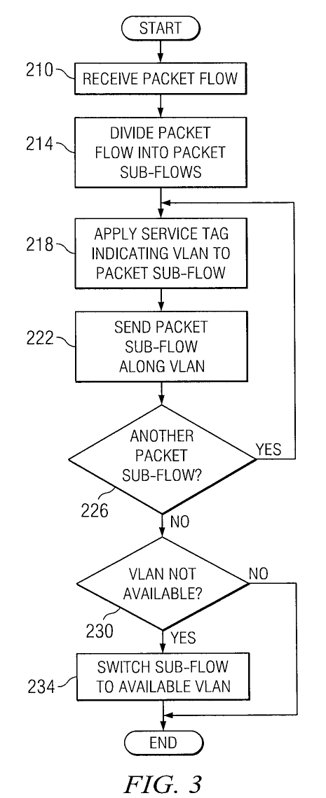

FIG. 3 illustrates one embodiment of a method for sending sub-flows along associated VLANs. The method may be performed in real time as sender 20a receives and sends packets.

The method begins at step 210, where sender 20a receives a packet flow with packets 28. Sender 20a divides a packet flow into sub-flows at step 214. The packet flow may be divided in any suitable manner. For example, packet flow may be divided according to priority to yield a first packet sub-flow comprising higher priority packets and a second packet sub-flow comprising lower priority packets. Higher priority packets may be packets that require guaranteed delivery, and lower priority packets may be packets that require only a best effort to be delivered. The higher priority packets may be required to be less than the bandwidth of the associated VLANs, but the lower priority traffic may be allowed to be greater than the bandwidth of the associated VLANs.

Sender 20a applies a service tag indicating a particular associated VLAN 26a to packets 28 of a packet sub-flow at step 218. Sender 20a sends the packet sub-flow along the particular VLAN 26a at step 222. Steps 218 and 22 may be performed substantially simultaneously as sender 20a sends different sub-flows along different VLANS.

There may be another packet sub-flow at step 226. For example, there may be a packet flow for the odd VLAN 26b. If there is another packet sub-flow at step 226, the method returns to step 218, where sender 20a applies a service tag that includes VLAN identifier N+1 indicating odd VLAN 26b to the packet sub-flow. If there is no other packet sub-flow at step 226, the method proceeds to step 230.

A VLAN 26 may not be available at step 230. For example, one of the associated VLANs 26a may have a failure. If a VLAN 26a is not available at step 230, the method proceeds to step 234. Sender 20a may switch the sub-flow at step 234 by applying the second service tag to the first packet sub-flow, and sending the first packet sub-flow to receiver 20b along the second VLAN 26b. Sender 20a may switch the sub-flow to the available VLAN 26b by applying the service tag indicating the available VLAN 26b to the packet sub-flow and sending the packet sub-flow to receiver 20b along the available VLAN 26b. If the VLANs 26 are available at step 230, the method ends.

Modifications, additions, or omissions may be made to the systems disclosed herein without departing from the scope of the invention. The components of the systems may be integrated or separated. Moreover, the operations of the systems may be performed by more, fewer, or other components. Additionally, operations of the systems may be performed using any suitable logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
routing a packet flow from a sender along a first VLAN of a plurality of VLANS to a receiver by:
applying a first service tag to the packet flow, the first service tag comprising a first VLAN identifier with a first masked portion indicating the first VLAN, the first masked portion masked to the receiver; and
sending the packet flow to the receiver along the first VLAN; and
switching the packet flow to a second VLAN of the plurality of VLANS associated with the first VLAN by:
applying a second service tag to the packet flow, the second service tag comprising a second VLAN identifier with a second masked portion indicating the second VLAN, the second masked portion masked to the receiver; and
sending the packet flow to the receiver along the second VLAN.

2. The method of claim 1, the switching the packet flow to the second VLAN associated with the first VLAN further comprising:
determining that a failure has been detected on the first VLAN; and
switching the packet flow to the second VLAN in response to the determination.

3. The method of claim 1, the switching the packet flow to the second VLAN associated with the first VLAN further comprising:
receiving a user request to switch the packet flow to the second VLAN; and
switching the packet flow to the second VLAN in response to the user request.

4. The method of claim 1, the switching the packet flow to the second VLAN associated with the first VLAN further comprising:
switching the packet flow to the second VLAN during a dead zone.

5. The method of claim 1, the switching the packet flow to the second VLAN associated with the first VLAN further comprising:
inserting a switching indicator packet into the packet flow to notify the receiver that the packet flow is being switched.

6. The method of claim 1:
the first VLAN identifier being N, the first masked portion comprising one or more least significant bits of the first VLAN identifier; and
the second VLAN identifier being N+1, the second masked portion comprising one or more least significant bits of the second VLAN identifier.

7. An apparatus comprising:
an interface configured to receive a packet flow; and
a processor configured to:
route the packet flow along a first VLAN of a plurality of VLANS to a receiver by:
applying a first service tag to the packet flow, the first service tag comprising a first VLAN identifier with a first masked portion indicating the first VLAN, the first masked portion masked to the receiver; and
sending the packet flow to the receiver along the first VLAN; and
switch the packet flow to a second VLAN of the plurality of VLANS associated with the first VLAN by:
applying a second service tag to the packet flow, the second service tag comprising a second VLAN identifier with a second masked portion indicating the second VLAN, the second masked portion masked to the receiver; and
sending the packet flow to the receiver along the second VLAN.

8. The apparatus of claim 7, the processor configured to switch the packet flow to the second VLAN associated with the first VLAN by:
determining that a failure has been detected on the first VLAN; and
switching the packet flow to the second VLAN in response to the determination.

9. The apparatus of claim 7, the processor configured to switch the packet flow to the second VLAN associated with the first VLAN by:
receiving a user request to switch the packet flow to the second VLAN; and
switching the packet flow to the second VLAN in response to the user request.

10. The apparatus of claim 7, the processor configured to switch the packet flow to the second VLAN associated with the first VLAN by:
switching the packet flow to the second VLAN during a dead zone.

11. The apparatus of claim 7, the processor configured to switch the packet flow to the second VLAN associated with the first VLAN by:
inserting a switching indicator packet into the packet flow to notify the receiver that the packet flow is being switched.

12. The apparatus of claim 7:
the first VLAN identifier being N, the first masked portion comprising one or more least significant bits of the first VLAN identifier; and
the second VLAN identifier being N+1, the second masked portion comprising one or more least significant bits of the second VLAN identifier.

13. A method comprising:
dividing a packet flow into a plurality of packet flows comprising a first packet sub-flow and a second packet sub-flow;
applying a first service tag to the first packet sub-flow, the first service tag comprising a first VLAN identifier with a first masked portion indicating a first VLAN of a plurality of VLANs, the first masked portion masked to the receiver;
sending the first packet sub-flow along the first VLAN to a receiver;
applying a second service tag to the second packet sub-flow, the second service tag comprising a second VLAN identifier with a second masked portion indicating a second VLAN associated with the first VLAN, the second masked portion masked to the receiver; and
sending the second packet sub-flow along the second VLAN to the receiver.

14. The method of claim 13, the dividing the packet flow further comprising:
dividing the packet flow according to priority to yield the first packet sub-flow comprising a plurality of higher priority packets and the second packet sub-flow comprising a plurality of lower priority packets.

15. The method of claim 13, further comprising:
determining that the first VLAN is not available;
applying the second service tag to the first packet sub-flow; and
sending the first packet sub-flow to the receiver along the second VLAN.

16. The method of claim 13:
the first VLAN identifier being N, the first masked portion comprising one or more least significant bits of the first VLAN identifier; and
the second VLAN identifier being N+1, the second masked portion comprising one or more least significant bits of the second VLAN identifier.

17. An apparatus comprising:
an interface configured to receive a packet flow; and
a processor configured to:
divide the packet flow into a plurality of packet flows comprising a first packet sub-flow and a second packet sub-flow;
apply a first service tag to the first packet sub-flow, the first service tag comprising a first VLAN identifier with a first masked portion indicating a first VLAN of a plurality of VLANs, the first masked portion masked to the receiver;
send the first packet sub-flow along the first VLAN to a receiver;
apply a second service tag to the second packet sub-flow, the second service tag comprising a second VLAN identifier with a second masked portion indicating a second VLAN associated with the first VLAN, the second masked portion masked to the receiver; and
send the second packet sub-flow along the second VLAN to the receiver.

18. The apparatus of claim 17, the processor configured to divide the packet flow by:
dividing the packet flow according to priority to yield the first packet sub-flow comprising a plurality of higher priority packets and the second packet sub-flow comprising a plurality of lower priority packets.

19. The apparatus of claim 17, the processor configured to:
determine that the first VLAN is not available;
apply the second service tag to the first packet sub-flow; and
send the first packet sub-flow to the receiver along the second VLAN.

20. The apparatus of claim 17:
the first VLAN identifier being N, the first masked portion comprising one or more least significant bits of the first VLAN identifier; and
the second VLAN identifier being N+1, the second masked portion comprising one or more least significant bits of the second VLAN identifier.
